(19) United States
(12) Patent Application Publication
(10) Pub. No.: US 2020/0001255 A1
(43) Pub. Date: Jan. 2, 2020

(54) CONICAL MIXER

(71) Applicant: Marion Process Solutions, Inc., Marion, IA (US)

(72) Inventors: Matt BANOWETZ, Tipton, IA (US); Michael BALL, Marion, IA (US)

(21) Appl. No.: 16/460,560

(22) Filed: Jul. 2, 2019

Related U.S. Application Data
(60) Provisional application No. 62/693,156, filed on Jul. 2, 2018.

(51) Int. Cl. B01F 7/20; B01F 15/02

(52) U.S. Cl. CPC B01F 7/20; B01F 15/00707; B01F 15/0266

(57) ABSTRACT

A conical mixer with two conical bodies that are sloped downward toward a discharge opening on a bottom, middle portion of the conical mixer. The conical mixer has a horizontally placed agitator axle with a plurality of agitator arms extending from the agitator axle. At least one paddle is attached to each agitator arms. As the agitator arms get closer to the middle, the length of the arms is increased. The conical mixer ensures proper mixing of the contents as well as using the slope of the conical bodies to assist in pushing the contents toward the discharge opening.

### CROSS-REFERENCE TO RELATED APPLICATIONS

The present application claims priority to provisional patent application 62/693,156 which was filed on Jul. 2, 2018, and is hereby expressly incorporated by reference in its entirety.

### BACKGROUND

During mixing operations and other related industrial operations, materials can accumulate in certain locations, particularly at the bottom of a mixer. Additionally, mixers typically have agitator arms of a particular consistent length.

It is an object of the invention to have a mixer with a sloped bottom to assist in discharge of the mixer contents.

It is a further object of the invention to provide a mixer with different agitator arm lengths to fit a conical shaped mixer.

### SUMMARY OF THE INVENTION

A conical or sloped-bottom mixer with different length agitator arms provides for the contents to be mixed thoroughly while assisting in the discharge of the contents out an opening in the bottom of the mixer. The chamber within the mixer is a larger diameter towards the middle than the diameter at the ends of the chamber allowing for a preferably five degree slope radiating out from the endplates. The trough walls slope downward leading toward a discharge opening. The contents of the mixer can be selectively emptied by placing the discharge opening in an open position.

The agitator arms are of a greater length for those arms toward the middle of the chamber compared to those arms that are closer to the ends of the chamber. Paddles are placed on the agitator arms and angled appropriately to efficiently mix the contents as well as assist with discharge of the contents through the discharge opening.

### BRIEF DESCRIPTION OF THE DRAWINGS

FIG. 1 is perspective view of the conical mixer without the agitator arms and paddles;

FIG. 2 is a front view of the conical mixer;

FIG. 3 is a cross sectional view of line A from FIG. 2;

FIG. 4 is a top view of conical mixer showing the agitating arms and paddles;

### DETAILED DESCRIPTION

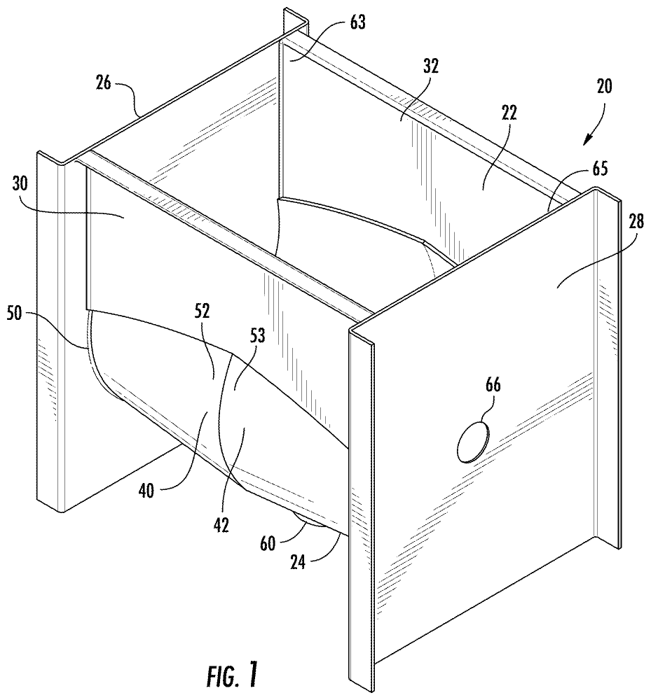

Now referring to the drawings, FIG. 1 shows a conical mixer 20. The mixer 20 comprises a chamber 22 defined by a first conical body 40, a second conical body 42, a first end plate 26, a second end plate 28, a front side 30 and a back side 32. The mixer 20 has a double conical body as seen in FIGS. 1-4. The first conical body 40 and the second conical body 42 meet in a middle 44 of the conical mixer 20 and form a bottom 24 of the conical mixer 20. It is to be understood that the first conical body 40 and second conical body 42 can be manufactured as one piece.

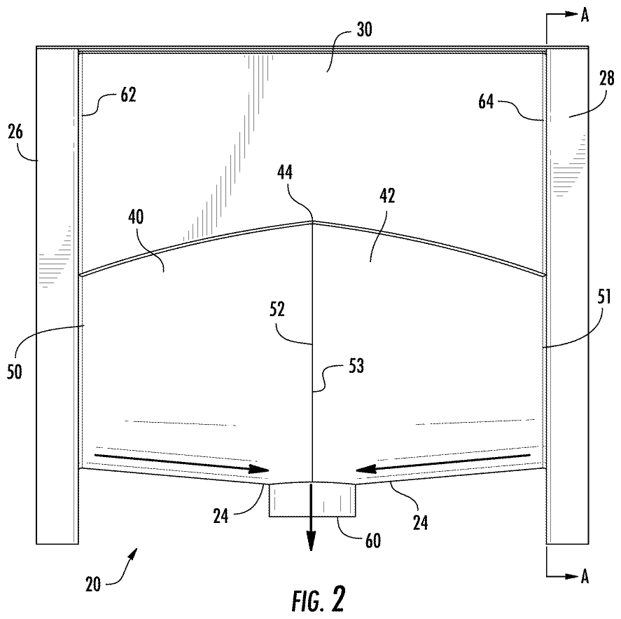

The first conical body 40 has a first side 50 and a second side 52. The second conical body 42 has a first side 51 and a second side 53. The first side 50 of the first conical body 40 is attached to the first end plate 26. The first side 51 of the second conical body 42 is attached to the second end plate 28. The second side 52 of the first conical body 40 is attached to the second side 53 of the second conical body 42 as best seen in FIGS. 1 and 2. As shown in FIG. 2, the bottom 24 of the mixer 20 is angled downward from where the first side 50 of the first conical body 40 makes contact with the first end plate 26 toward where the first conical body 40 attaches to the second conical body 40. Similarly, the bottom 24 of the mixer 20 is angled downward from where the first side 51 of the second conical body 42 makes contact with the second end plate 28 toward where the second conical body 42 attaches to the first conical body 42. The near horizontal arrows in FIG. 2 indicate the slope. In the preferred embodiment, the slope is five degrees.

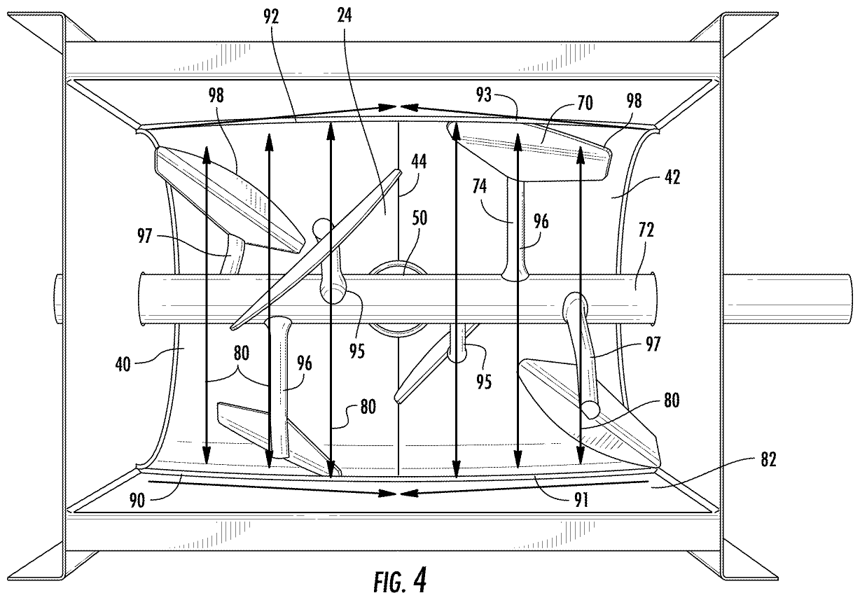

As best seen in FIGS. 2 and 4, a discharge opening 60 is located in the bottom 24 of the conical mixer 20, preferably in a middle 44 of the conical mixer 20. The discharge opening 60 can be selectively opened and closed. Accordingly, the contents of the conical mixer 20 will naturally direct toward the bottom 24 and then due to the slope toward the middle 44 and then exit through the discharge opening 60.

The front side 30 is located above the first conical body 40 and the second conical body 42. A first end 62 of the front side 30 is attached to the first end plate 26. Similarly, a second end 64 of the front side 30 is attached to the second end plate 28. The back side 32 is also located above the first conical body 40 and the second conical body 42. A first end 63 of the back side 32 is attached to the first end plate 26. Similarly, a second end 65 of the back side 32 is attached to the second end plate 28.

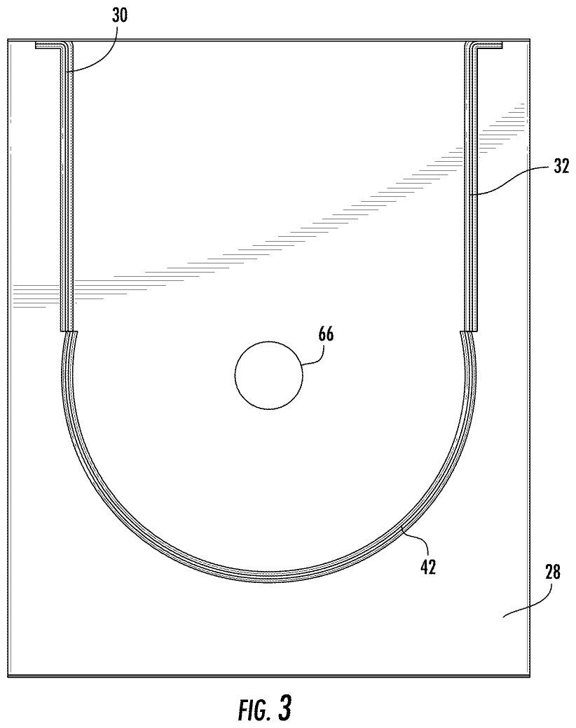

The first end plate 26 and the second end plate 28 have an opening 66 such that an agitator axle 72 can be fitted through the openings 66. Preferably, the agitator axle 72 is cylindrical. Attached to the agitator axle 72 are a plurality of agitator arms 74, each having a particular length. In the preferred embodiment, at least one paddle 70 is attached to each agitator arm 74. Due in part to the conical shape and the slope described above, as shown in FIG. 4, the agitators arms 74 must have different lengths to be more efficient at mixing the contents. The lines 80 with double arrows in FIG. 3 indicate the distance (a diameter) from a front 90 of the first conical body 40 to a back 92 of the first conical body 40, or from a front 91 of the second conical body 42 to a back 93 of the second conical body 42. As shown, there is a greater distance the further the lines get toward the middle 44.

Accordingly, the arms 74 will be longer as they get closer to the middle 44. In FIG. 4, this is demonstrated as agitator arms labeled as 95 will have a greater length than those labeled as 96. Furthermore, those labeled 96 will have a greater length than those arms labeled as 97. Another way to reach the same effect could be to lengthen the paddles 70 or lengthen a combination of the arms 74 and paddles 70 as they get closer to the middle 44. It is to be understood that the length of the arms can include the length of a paddle 70. The edges 98 of a paddle 70 are meant to either just make contact with the first conical body 40 and/or the second conical body 42, or nearly contact the first conical body 40 and/or the second conical body 42. If there is not to be actual contact, the conical mixer is made such that the distance from the edges 98 is minimal, preferably less than a few millimeters. It is to be further understood that the agitator arms 74 can be attached to ribbons to form a ribbon mixer instead of a paddle mixer, but still have the novelties of the invention.

Having thus described the invention in connection with the several embodiments thereof, it will be evident to those skilled in the art that various revisions can be made to the embodiments described herein without departing from the spirit and scope of the invention. It is the intention, however, that all such revisions and modifications that are evident to those skilled in the art will be included with in the scope of the following claims. Any elements of any embodiments disclosed herein can be used in combination with any elements of other embodiments disclosed herein in any manner to create different embodiments.

What is claimed is:

1. A conical mixer, comprising:
a first conical body;
a second conical body;
the first conical body connected to the second conical body;
a bottom;
a middle;
the first conical body having a first end and a second end;
the second conical body having a first end and a second end;
the first conical body sloped downward toward the second end of the first conical body from the first end of the first conical body;
the second conical body sloped downward toward the second end of the second conical body from the from the first end of the second conical body.

2. The conical mixer of claim 1, further comprising:
an agitator axle;
a plurality of agitator arms extending from the agitator axle;
at least one paddle extending from each agitator axle.

3. The conical mixer of claim 2, further comprising:
a first agitator arm of the plurality of agitator arms has a first end and a second end;
a second agitator arm of the plurality of agitator arms has a first end and a second end;
the first agitator arm more toward the first end of the first conical body than the second agitator arm;
the first agitator arm having a length lesser than a length of the second agitator arm.

4. The conical mixer of claim 3, further comprising:
a discharge opening.

5. The conical mixer of claim 4, wherein:
the discharge opening is located on the bottom.

6. The conical mixer of claim 5, wherein:
the discharge opening is located in the middle.

7. The conical mixer of claim 6, wherein:
the second end of the first conical body attached to the second end of the second conical body.

8. The conical mixer of claim 7, further comprising:
a first end plate and a second end plate;
the first end plate having an opening;
the second end plate having an opening;
the agitator axle placed within the opening of the first end plate and the opening of the second end plate;
wherein the agitator axle can rotate.

9. The conical mixer of claim 8, further comprising:
a first side wall and a second side wall;
the first side wall located above the first conical body and the second conical body.

10. The conical mixer of claim 9, wherein:
the plurality of paddles are configured to a shape and angle that a portion of the paddle will make contact with either the first conical body or the second conical body.

11. A conical mixer, comprising:
a first conical body;
a second conical body;
the first conical body connected to the second conical body;
a bottom;
a middle;
the first conical body having a first end and a second end;
the second conical body having a first end and a second end;
the first conical body sloped downward toward the second end of the first conical body from the first end of the first conical body;
the second conical body sloped downward toward the second end of the second conical body from the from the first end of the second conical body;
a first agitator arm having a first end and a second end;
a second agitator arm having a first end and a second end;
the first agitator arm more toward the first end of the first conical body than the second agitator arm;
the first agitator arm having a length lesser than a length of the second agitator arm.

12. The conical mixer of claim 11, further comprising:
a discharge opening.

13. The conical mixer of claim 12, wherein:
the discharge opening is in the bottom.

14. The conical mixer of claim 13, further comprising:
an agitator axle;
the first and second agitator arms extending from the agitator axle;
at least one paddle extending from each agitator axle.

15. The conical mixer of claim 14, the second end of the first conical body attached to the second end of the second conical body.

16. The conical mixer of claim 15, further comprising:
a first end plate and a second end plate;
the first end plate having an opening;
the second end plate having an opening;
the agitator axle placed within the opening of the first end plate and the opening of the second end plate;
wherein the agitator axle can rotate.

17. The conical mixer of claim 16, further comprising:
a first side wall and a second side wall;
the first side wall located above the first conical body and the second conical body.

18. The conical mixer of claim 17, wherein:
the plurality of paddles are configured to a shape and angle that a portion of the paddle will make contact with either the first conical body or the second conical body.

19. The conical mixer of claim 18, wherein:
the discharge opening is located in the middle.

20. The conical mixer of claim 19, wherein:
the first conical body has a downward slope from the first end to the second end.
